(19) United States
(12) Patent Application Publication
(10) Pub. No.: US 2006/0089838 A1
(43) Pub. Date: Apr. 27, 2006

(54) Method of streaming multimedia data

(75) Inventors: Philippe Gentric, Fourqueux (FR); Nicolas Delahaye, Courbevoie (FR); Yves Ramanzin, Paris (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/525,471

(22) PCT Filed: Aug. 21, 2003
(86) PCT No.: PCT/IB03/03766

§ 371 Date: Feb. 23, 2005

(30) Foreign Application Priority Data
Aug. 28, 2002 (EP) 02292121.7

(51) Int. Cl. G06Q 99/00

(52) U.S. Cl. 705/1

(57) ABSTRACT

The invention relates to a method of streaming multimedia for providing seamless stream switching. The method consists in streaming multimedia data from a server (15) to a client (14) over a network (13) having a variable bandwidth. The client is intended to decode a subset of streams within a set of streams having various predetermined bit rates. The decoded subset of streams has bit rates compatible with the network bandwidth. The method comprises the steps of configuring the client so that the client can decode all the streams within the set of streams, playing all the streams within the set of streams and muting all the streams within the set of streams, except the subset of streams.

### FIELD OF THE INVENTION

The present invention relates to a method of streaming multimedia data from a server to a client over a network having a variable bandwidth, the client being intended to decode a subset of streams within a set of streams having various predetermined bit rates, said subset of streams having bit rates compatible with the network bandwidth.

The present invention also relates to a server and a client for carrying out this method, a telecommunication system implementing this method and a computer program for carrying out this method.

The present invention is particularly relevant for systems of multimedia streaming over networks whose effective instantaneous bandwidth may vary with time. For example, it applies to transmissions over mobile telephony systems using various transmission standards such as MPEG4 (Moving Expert Picture Group-4) or H263.

### BACKGROUND OF THE INVENTION

Multimedia networks such as the GPRS (General Packet Radio System) or UMTS (Universal Mobile Telephony System) and the Internet do not provide a guaranteed quality of service. The effective instantaneous bandwidth varies with time because of congestions, transmission errors or resource sharing for instance. In the framework of multimedia streaming over such networks, adaptation mechanisms to these variations have to be provided in order to minimize data losses on the one hand and maximize the quality of the content received by the client on the other hand.

A classical approach to this problem is known as “Stream Switching”. The same content is encoded by a media encoder into a set of streams at several bit rates. With respect to the currently available bandwidth, an adequate stream, i.e. having an adequate bit rate with respect to the available bandwidth, is selected to be transmitted to the client via a media server, which operates the corresponding stream switching, for selecting said adequate stream to be sent.

The way a stream switching is usually performed is described hereinafter. Based on the bit rates of the various streams and on the available bandwidth, the server selects a stream having a bit rate compatible with the available bandwidth. The server can also select a subset of streams, when the client is intended to decode simultaneously many streams, e.g. an audio and a video stream. In the following, a “subset of streams” shall designate one stream or a few streams. If the selected subset of streams differs from the subset of streams currently decoded by the client, a stream switching is performed.

In order to perform such a stream switching, information concerning the selected subset of streams is communicated to the client, so that the client can change its configuration in order to be able to decode this selected subset of streams, with respect to the content and bit rates of this selected subset of streams.

Thus, when a server switches from one subset of streams to another one, e.g. in order to adapt the bit rate of the delivered subset of streams to the available bandwidth of the network, a new decoder configuration corresponding to the new delivered subset of streams has to be sent to the client decoder. The decoder is then reinitialised with the new decoder configuration. The stream switching is therefore not seamless for the client and may impact the service quality from the end user's point of view.

For example, suppose one wants to perform a stream switching using the IETF (Internet Engineering Task Force) standard, which is RTSP (Real Time Streaming Protocol) described in “Real Time Streaming Protocol (RTSP), RFC2326, April 1998” written by Schulzrinne H. et al. The following commands have to be sent by the client to the server:
TEARDOWN: to stop the current subset of streams
DESCRIBE: to get information on the new subset of streams
SETUP: to configure the new session, ie to indicate to the server that the decoder has been reinitialised
PLAY: to start streaming the new subset of streams in the new session.
   These commands and the answer to these commands require a long time, for example a few seconds. Actually, each request from the client to the server is followed by an acknowledgment sent by the server to the client, which means that each command requires a whole round trip over the network. The service is therefore interrupted on the end user side during a few seconds, which is not acceptable.

### SUMMARY OF THE INVENTION

It is an object of the invention to provide a method of streaming multimedia data, which leads to a seamless stream switching.

To this end, a method of streaming multimedia data according to the invention, as described in the opening paragraph, is characterised in that it comprises the steps of configuring the client so that the client can decode all the streams within the set of streams, playing all the streams within the set of streams and muting all the streams within the set of streams, except the subset of streams.

According to the invention, the client decoder is first configured in order to be able to decode all streams within the set of streams. Then, all streams within the set of streams are played, but a large number of these streams are muted, i.e. they do not reach the final decoder in order to be decoded. Only the subset of streams compatible with the network bandwidth is not muted, i.e. reaches the client decoder to be decoded. When a stream switching is to be performed between a currently decoded subset of streams and a next subset of streams, the currently decoded subset of streams is muted and the next subset of streams is simply unmuted. Such a stream switching thus only requires muting and unmuting two subsets of streams, and does not require any configuration of a new session. Such a stream switching is therefore seamless.

Advantageously, the step of muting all the streams except the subset of streams is performed by the server on a request from the client in accordance with the MUTE/UNMUTE extension of the Real Time Streaming Protocol. The method uses standard IETF protocols so that servers and clients implemented by different parties can interoperate.

These and other aspects of the invention will be apparent from and elucidated with reference to the embodiments described hereinafter.

### BRIEF DESCRIPTION OF THE DRAWINGS

The invention will now be described in more detail, by way of example, with reference to the accompanying drawings, in which:

FIG. 1 is a block diagram illustrating a telecommunication system comprising a server and a client according to the invention;

FIG. 2 is a block diagram illustrating a telecommunication system with a client according to a first embodiment of the invention;

FIG. 3 is a block diagram illustrating a telecommunication system with a client according to a second embodiment of the invention;

FIG. 4 is a diagram for illustrating a method of streaming and a stream switching according to the invention.

### DETAILED DESCRIPTION OF THE INVENTION

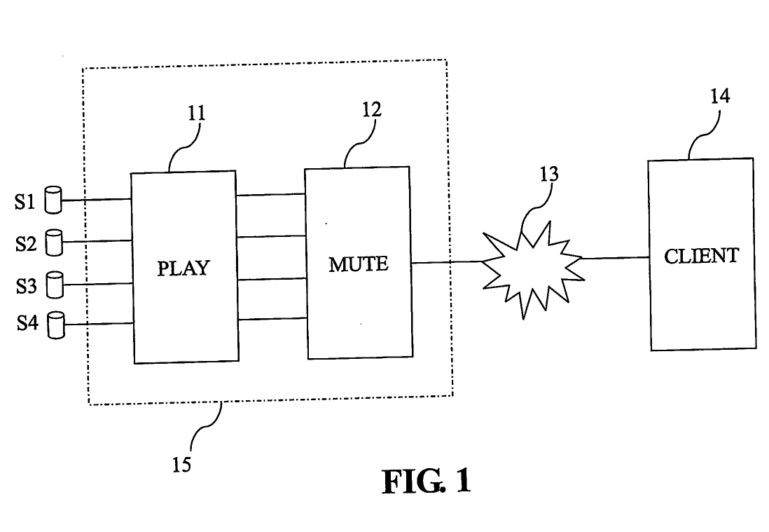

A telecommunication system according to the invention is depicted in FIG. 1. Such a telecommunication system comprises a server 15 comprising playing means 11 and muting means 12, a network 13 and a client 14. The network 13 is, for example, a mobile radiotelephony network or the Internet network.

The server 15 receives a set of streams {S1, S2, S3, S4}. These streams correspond to a multimedia content produced by a multimedia source, after encoding. For a given multimedia source, all the produced encoded streams within the set {S1, S2, S3, S4} comprise the same multimedia content, but have different predetermined bit rates. The bit rates are predetermined in order for the system to be able to provide the client 14 with a set of various qualities of services, selected on the one hand with respect to the nature of the transmitted content, each content (audio, fixed images, video, etc.) requiring a specific available bandwidth, and on the other hand with respect to the quality of service required by the end user on the client side.

The various available bit rates are also useful to enable the system to cope with variations of the available bandwidth, which often cause a reduction of the bit rate of the transmitted streams. As a matter of fact, the network's effective bandwidth may vary with time with respect to several parameters. These parameters include current traffic and radio transmission conditions, which may considerably affect the current available bandwidth. With respect to this current available bandwidth and the required quality of service, the adequate stream has to be delivered to the client 13.

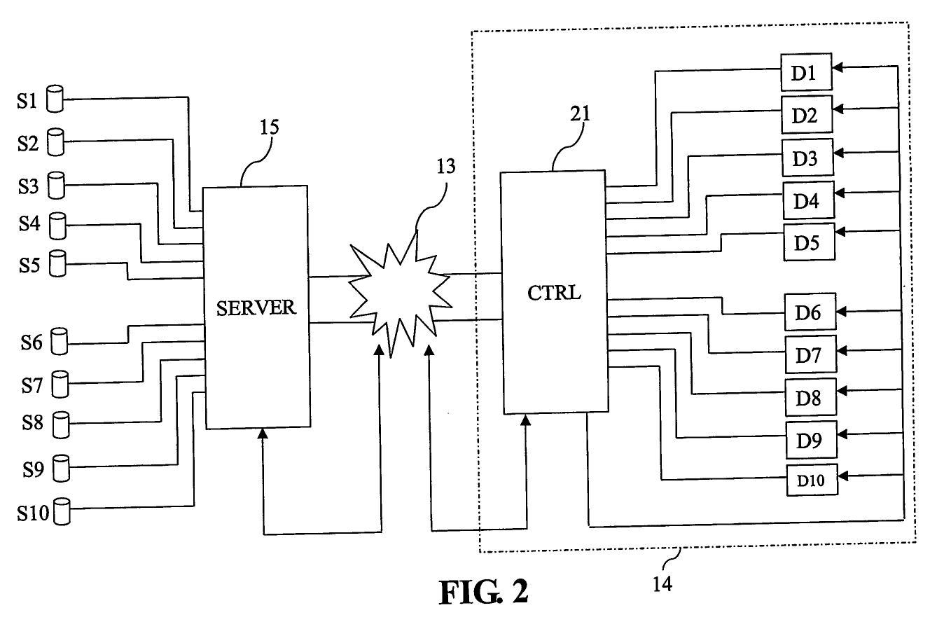

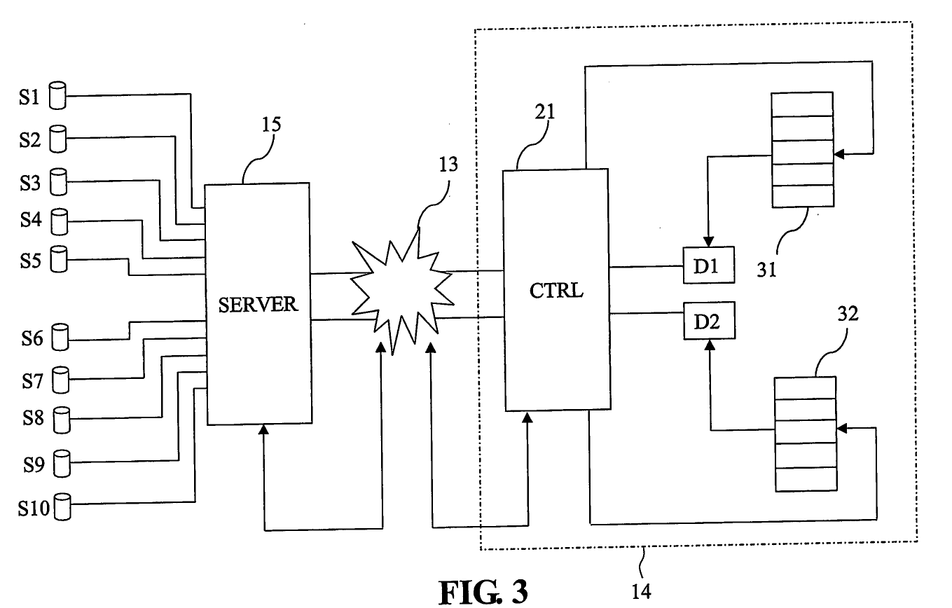

The method of streaming multimedia data according to the invention is described hereinafter. When the client 14 desires to decode a multimedia content, it first asks the server 15 for information about the various streams S1 to S4 comprising this multimedia content. This information comprises the bit rates of each stream S1 to S4. Using this information, the client 13 is configured so that it can decode all the streams within the set of streams {S1, S2, S3, S4}. How such a configuration is performed is described in FIGS. 2 and 3. Then, according to the available network bandwidth, a subset of streams is selected, which is to be decoded by the client 14.

The measure of the available bandwidth can be performed by the server 15. In this case, the server 15 will select the subset of streams to be decoded by the client 14. This is particularly advantageous when the server 15 has information about the client 14, for example the various decoders available in client 14. The measure of the available bandwidth can also be performed by the client 14. In this case, the client 14 will select the subset of streams to be decoded. This would be the case, for example, in a mobile radiotelephony network, where a lot of different clients are linked to a same server. Actually, in such a network, the server 15 cannot have information about all the clients in the network. The available bandwidth can also be measured by the server 15 and sent to the client 14, which will then select the subset of streams to be decoded.

Suppose the subset of streams to be decoded by the client 14 is the stream S1. Then all the streams within the set of streams {S1, S2, S3, S4} are played by the server 15, thanks to the playing means 11, but the streams S2, S3 and S4 are muted, thanks to the muting means 12. Playing and muting a stream means that the stream is virtually played by the playing means 11, but the stream does not reach the client 14 and the virtual play does not consume any resource on the server side. For example, suppose a stream comprises 10 stream elements enumerated 1 to 10, the first stream element 1 being played at a first time t1, the second stream element 2 at a time t2 and so on, and suppose the stream is muted at time t4 and unmuted at time t8. Then the client 14 receives the stream elements 1 to 3 and, after a time equal to t8−t4, the client 14 receives the stream elements 8 to 10.

As the streams S2, S3 and S4 are muted, the client 14 only receives the stream S1 and can decode this stream because it has been configured in order to be able to decode all the streams. Suppose the available bandwidth changes and a stream switching is to be performed, for example the stream S2 is selected to be decoded by the client 14. In order to perform such a stream switching, the stream S1 is muted and the stream S2 is unmuted, so that only the stream S2 reaches the client 14, which stream S2 can be decoded by the client 14 because it has been configured in order to be able to decode all the streams.

The method in accordance with the invention thus allows performing a seamless stream switching. Actually, the time required to mute a stream and unmute another stream on the server side is very small, so that there is no service interruption on the client side, which could be noticed by an end user. The end user on the client side might be aware that a stream switching has been performed, because the quality of the currently decoded stream might have changed. Compared to a stream switching in accordance with the state of the art, the stream switching performed by the method in accordance with the invention does not require configuring a new session each time a new stream is selected to be decoded by the client 14, because a session is already established for each stream within the set of streams {S1, S2, S3, S4}, as these streams are played by the playing means 11. As a consequence, the stream switching according to the invention is much more seamless than a stream switching according to the state of the art.

It is important to notice than the muting means 12 might be separated from the server 15. For example, the muting means 12 might be a separate device placed between the server 15 and the client 13, or might form part of the client 14.

FIG. 2 illustrates a telecommunication system according to a first embodiment of the invention. This telecommunication system comprises the server 15, the network 13 and the client 14. The client 14 comprises a controller 21 and ten decoders D1 to D10.

In the following example, a multimedia content to be decoded by the client 14 has been encoded into 10 streams S1 to S10, forming a set of streams {S1-S10}. The five first streams S1 to S5 contain a video content and the five last streams S6 to S10 contain an audio content. Playing the multimedia content consists in playing one video stream and one audio stream. Examples of streams S1 to S10 are given in the 2 following tables, which principally define the formats of the streams and their bit rates.

| Stream | Format | Size | Profile | Frames/sec | Bit Rate |
|---|---|---|---|---|---|
| S1 | H263 | QCIF | Single | 2 | 25 |
| S2 | MPEG-4 | QCIF | Single | 10 | 50 |
| | video | | | | |
| S3 | MPEG-4 | QCIF | Single | 25 | 100 |
| | video | | | | |
| S4 | MPEG-4 | CIF | Single | 25 | 200 |
| | video | | | | |
| S5 | MPEG-4 | CIF | Advanced | 25 | 400 |
| | video | | simple | | |

| Stream | Format | Bit Rate |
|---|---|---|
| S6 | Adaptive Multi-Rate | 5 |
| S7 | Code Excited Linear Prediction | 10 |
| S8 | Advanced Audio Coding mono | 32 |
| S9 | Advanced Audio Coding stereo | 64 |
| S10 | Advanced Audio Coding + advanced tools | 128 |

When the client 14 desires to decode the multimedia content, the controller 21 asks for information about each stream S1 to S10. For example, the multimedia content might be contained in a file, which has an URL address (URL stands for Universal Resource Locator). Knowing the address of the content, the controller 21 asks for a description of the streams comprising this multimedia content, by sending a request to the server 15 via the network 13. For example, if the RTSP protocol is used, such a request is a “DESCRIBE” command which has the following structure:
DESCRIBE rtsp://movie RTSP/1.0
CSeq: 1.

In this command, the URL address of the multimedia content is “rtsp://movie”, the protocol used is “RTSP/1.0” and the sequence number Cseq of this message is 1.

The server 15 then sends the descriptions of the streams comprising the desired multimedia content. The messages sent by the server 15 to the client 14 have the following structure:
RTSP/1.0 200 OK
CSeq: 1
Content-Type: application/sdp
Content-Length: xxx
a=control:rtsp://movie
T=0 0
m=video 7722 RTP/AVP 96
a=rtpmap:96 MP4V-ES/1000
a=control:rtsp://movie/video1
a=br:400
m=audio 7724 RTP/AVP 97
a=rtpmap:97 mpeg4-generic/44100/2
a=control:rtsp://movie/audio1
a=br:128
m=video 7726 RTP/AVP 98
a=rtpmap:98 MP4V-ES/1000
a=control:rtsp://movie/video2
a=br:200
m=audio 7724 RTP/AVP 99
a=rtpmap:99 mpeg4-generic/44100/2
a=control:rtsp://movie/audio2
a=br:68

These messages correspond to a description of the streams S5, S10, S4 and S9, respectively.

As the description of a given stream comprises the format of the stream and its bit rate, the controller can configure one of its decoders so that this decoder is able to decode the given stream. In the example of FIG. 2, the decoder D1 is configured to decode the stream S1, the decoder D2 is configured to decode the stream S2 and so on.

The client 14 and the server 15 also have to agree on transport parameters, i.e. UDP port numbers. This is effected thanks to a SETUP command, which has the following structure, given for the stream S10:
SETUP rtsp://movie/audio1 RTSP/1.0
CSeq: 2
Transport: RTP/AVP;unicast;client_port=8000-8001

The server then answers this message by sending a message having the following structure:
RTSP/1.0 200 OK
CSeq: 2
Transport: RTP/AVP;unicast;client_port=8000-8001; server_port=9000-9001
Session: 12345678

In the following, we suppose that the measure of the bandwidth is performed by the client 14, e.g. by the controller 21, and that the client 14 selects the subset of streams compatible with the available bandwidth.

Once the decoders of the client 14 have been configured, a subset of streams to be decoded by the client 14 is selected, for example the streams S5 and S10.

Then the controller 21 requests that the streams S1 to S4 and S6 to S9 are muted. Such a request is sent via the network 13 to the server 15, which comprises muting means. If the RTSP protocol is used, such a request uses the MUTE extension of this protocol, and has the following structure, given for the streams S9 and S4:
MUTE rtsp://movie/audio2 RTSP/1.0
CSeq: 8
Session: 12345678
MUTE rtsp://movie/video2 RTSP/1.0
CSeq: 9
Session: 12345678

The streams S1 to S10 are then played by the server 15. For example, the client 14 can request that the streams S1 to S10 are played. If the RTSP protocol is used, such a request uses the PLAY command and has the following structure:
PLAY rtsp://movie RTSP/1.0
CSeq: 12
Range: npt=0−
Session: 12345678

The server then sends an acknowledgment, which has the following structure:
RTSP/1.0 200 OK
CSeq: 12
Session: 12345678

As all streams within the set of streams {S1-S10} are muted, except the streams S5 and S10, the streams S5 and S10 reaches the controller 21, which sends them to the decoders D5 and D10, respectively. The controller might comprise switches or multiplexers in order to send the incoming streams to the right decoders. The controller 21 might also comprise a plurality of ports, each assigned to one decoder, and receive a given stream on the port corresponding to the decoder intended to decode this given stream.

Suppose a stream switching is to be performed because the available bandwidth has decreased. For example, the client 14 would like to play the streams S4 and S9, which have lower bit rates than the streams S5 and S10, respectively. The controller 21 then requests that the streams S5 and S10 are muted and that the streams S4 and S9 are unmuted. Such a request is sent via the network 13 to the server 15. If the RTSP protocol is used, such a request uses the MUTE/UNMUTE extension of this protocol, and has the following structure:
MUTE rtsp://movie/audio1 RTSP/1.0
CSeq: 13
Session: 12345678
MUTE rtsp:/movie/video1 RTSP/1.0
CSeq: 14
Session: 12345678
UNMUTE rtsp://movie/audio2 RTSP/1.0
CSeq: 15
Session: 12345678
UNMUTE rtsp://movie/video2 RTSP/1.0
CSeq: 16
Session: 12345678

The server then sends an acknowledgment, which has the following structure:
RTSP/1.0 200 OK
CSeq: 13
Session: 12345678
RTSP/1.0 200 OK
CSeq: 14
Session: 12345678
RTSP/1.0 200 OK
CSeq: 15
Session: 12345678
RTSP/1.0 200 OK
CSeq: 16
Session: 12345678

Then, when the streams S4 and S9 reach the client 14, the controller 21 sends them to the decoders D4 and D9, respectively.

FIG. 3 illustrates a telecommunication system according to a second embodiment of the invention. The client 14 comprises two decoders D1 and D2, and two memories 31 and 32. The first decoder D1 is able to decode video streams and the second decoder D2 is able to decode audio streams.

In this embodiment, the decoders D1 and D2 are configured by means of configuring parameters, which are loaded in the memories 31 and 32. When the server 15 sends a description of each stream within the set of streams {S1-S10} via the network 13 to the client 14, the controller 21 computes decoding parameters P1 to P10 and loads these parameters into the memories 31 and 32. The parameters P1 are computed in such a way that, knowing these parameters, the decoder D1 is able to decode the stream S1. The parameters P2 are computed in such a way that, knowing these parameters, the decoder D1 is able to decode the stream S2, and so on. The parameters P1 to P5 are loaded into the memory 31 and used to configure the decoder D1. The parameters P6 are computed in such a way that, knowing these parameters, the decoder D2 is able to decode the stream S6, and so on. The parameters P6 to P10 are loaded into the memory 32 and used to configure the decoder D2.

When a given subset of streams is to be decoded by the client 14, as has been described hereinbefore, the configuring parameters corresponding to this given subset of streams are sent to the decoders D1 and D2 by the controller 21, in order to configure these decoders so that they can decode the given subset of streams. Such a configuration might require a certain time. When a stream switching is effected, a new configuration has to be sent to the decoders, i.e. new configuring parameters have to be sent to the decoders.

Suppose the stream S1 is decoded by the decoder D1, and a stream switching is effected in order to decode the stream S2. The decoder D1 keeps its configuration corresponding to the parameters P1 until there is no more data from the stream S1 reaching the decoder D1. At that time, the stream S2 reaches the decoder D1, but the decoder D1 is not able to decode the stream S2 because the reconfiguration requires a certain time. This might lead to service interruptions. To solve this problem, a buffer might be used between the decoder and a display intended to display the decoded streams. This buffer stores decoded streams, i.e. audio and/or video, corresponding to a time which is at least the time required for the reconfiguration of the decoders.

Thanks to this buffer, the end user does not detect any service interruption, because decoded streams are fetched from the buffer and displayed while the decoders are being reconfigured.

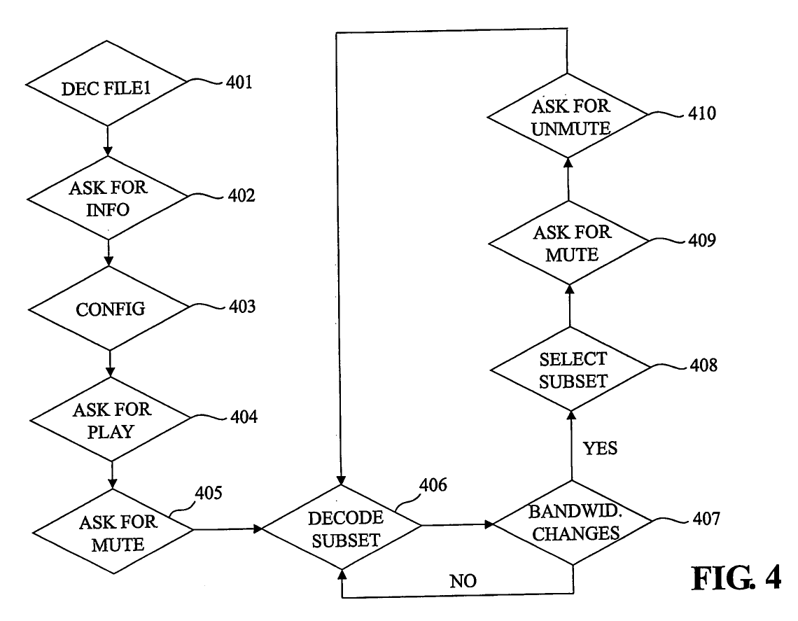

FIG. 4 illustrates a method of streaming multimedia and a stream switching according to the invention. Such a method might be implemented by the client 14 of FIGS. 2 and 3.

At step 401, the client 14 desires to decode a multimedia content, which is, for example, comprised in a file having an URL address. At step 402, the client 14 asks for information about the various streams comprising the multimedia content. At step 403, the client is configured in order to be able to decode all the streams comprising the desired multimedia content. Such a configuration might be performed as has been described in FIG. 2 or 3.

At step 404, the client 14 requests that the streams comprising the desired multimedia content are played and, at step 405, the client requests that the streams are muted, except a subset of streams which the client desires to decode, i.e. the subset of streams having bit rates compatible with the current available bandwidth. The steps 404 and 405 advantageously are simultaneous. At step 406, the unmuted subset of streams, which reaches the client 14, is decoded. This step 406 might require a decoder configuration if a client in accordance with the second embodiment of the invention is used, as has been described in FIG. 3.

At step 407, the client 14 checks if the bandwidth has changed. If the bandwidth has not changed, the currently decoded subset of streams stays unmuted and the client 14 decodes this subset of streams. If the bandwidth has changed, a subset of streams to be decoded is selected according to the new available bandwidth, at step 408. If this subset of streams is different from the currently decoded subset of streams, the client requests, at step 409, that the currently decoded subset of streams is muted and, at step 410, that the new subset of streams to be decoded is unmuted. The steps 409 and 410 advantageously are simultaneous. Then, the new subset of streams is decoded at step 406.

The method for streaming multimedia according to the invention can be implemented in an integrated circuit, which is intended to be integrated in a server or in a client. A set of instructions that is loaded into a program memory causes the integrated circuit to carry out the method for streaming multimedia. The set of instructions may be stored on a data carrier such as, for example, a disk. The set of instructions can be read from the data carrier so as to load it into the program memory of the integrated circuit, which will then fulfil its role.

Any reference sign in the following claims should not be construed as limiting the claim. It will be obvious that the use of the verb “to comprise” and its conjugations does not exclude the presence of any other elements or steps besides those defined in any claim. The word “a” or “an” preceding an element or a step does not exclude the presence of a plurality of such elements.

1. A method of streaming multimedia data from a server (15) to a client (14) over a network (13) having a variable bandwidth, the client being intended to decode a subset of streams within a set of streams (S1, S10) having various predetermined bit rates, said subset of streams having bit rates compatible with the network bandwidth, the method being further characterised in that it comprises the steps of configuring the client so that the client can decode all the streams within the set of streams, playing all the streams within the set of streams and muting all the streams within the set of streams, except the subset of streams.

2. A method of streaming multimedia data according to claim 1, wherein the step of muting all the streams except the subset of streams is performed by the server on a request from the client in accordance with the MUTE/UNMUTE extension of the Real Time Streaming Protocol.

3. A server (15) for serving a client (14) with a subset of streams over a network (13) having a variable bandwidth, said server comprising means for selecting the subset of streams within a set of streams having various predetermined bit rates, means for playing (11) all the streams within the set of streams and means for muting (12) all the streams within the set of streams, except the subset of streams.

4. A server as claimed in claim 3, wherein the means for selecting the subset of streams comprise means for measuring the network bandwidth.

5. A server as claimed in claim 3, wherein the means for selecting the subset of streams are controlled by a request from the client.

6. A client (14) intended to decode a subset of streams within a set of streams having various predetermined bit rates, said streams being sent over a network (13) having a variable bandwidth, said client comprising configuring means (21) in order to be able to decode all the streams within the set of streams, means for selecting a subset of streams having bit rates compatible with the network bandwidth and means for muting all the streams within the set of streams, except the subset of streams.

7. A telecommunication system comprising a server for serving a client with a subset of streams, said server comprising means for selecting the subset of streams within a set of streams having various predetermined bit rates, means for playing all the streams within the set of streams and means for muting streams, a network having a variable bandwidth and a client intended to decode the subset of streams, said client comprising configuring means in order to be able to decode all the streams within the set of streams, means for selecting a subset of streams having bit rates compatible with the network bandwidth and means for requesting that all the streams within the set of streams, except the subset of streams, are muted.

8. A computer program comprising a set of instructions which, when loaded into a processor or a computer, causes the processor or the computer to carry out the method as claimed in claim 1.
